(19) United States
(12) Patent Application Publication
(10) Pub. No.: US 2024/0322273 A1
(43) Pub. Date: Sep. 26, 2024

(54) METHOD FOR CONTROLLING BATTERY PACK AND CONTROLLER

(71) Applicant: Prime Planet Energy & Solutions, Inc., Tokyo (JP)

(72) Inventors: Daichi KOBORI, Kobe-shi (JP); Hiroshi ONIZUKA, Toyota-shi (JP)

(21) Appl. No.: 18/607,564

(22) Filed: Mar. 18, 2024

(30) Foreign Application Priority Data
Mar. 22, 2023 (JP) 2023-045083

(51) Int. Cl. H01M 10/44; H01M 10/48; H01M 50/209; H01M 50/293

(52) U.S. Cl. CPC H01M 10/441; H01M 10/482; H01M 10/488; H01M 50/209; H01M 50/293

(57) ABSTRACT

According to the present disclosure, a method for controlling a battery pack that includes a plurality of rectangular secondary batteries and a porous elastic member disposed between adjacent ones of the rectangular secondary batteries in an arrangement direction is provided. The control method includes a normal discharge step of discharging the rectangular secondary batteries such that a charge state of the rectangular secondary batteries does not become lower than a preset lower limit charge state, and a refresh discharge step of discharging the rectangular secondary batteries until the charge state of the rectangular secondary batteries becomes lower than the lower limit charge state when the normal discharge processing is not being performed.

### CROSS REFERENCE OF RELATED APPLICATION

This application claims the benefit of priority to Japanese Patent Application No. 2023-045083 filed on Mar. 22, 2023. The entire contents of this application are hereby incorporated herein by reference.

### BACKGROUND OF THE DISCLOSURE

### 1. Field

The present disclosure relates to a method for controlling a battery pack and a controller.

### 2. Background

In power sources for vehicle driving or the like, battery packs in which a plurality of secondary batteries (cells) are electrically connected to each other for higher output have been used conventionally. Conventional technical literatures related to the battery pack include WO 2018/061894. For example, WO 2018/061894 discloses a battery pack including a plurality of secondary batteries that are arranged in a predetermined arrangement direction, a heat conduction suppressing member that is disposed between the secondary batteries adjacent in the arrangement direction, and a restriction mechanism that restricts the plurality of secondary batteries and the heat conduction suppressing member.

In WO 2018/061894, the heat conduction suppressing member includes a porous material. The porous material includes a plurality of communication holes that communicate with the outside. Thus, when the secondary batteries expand, for example, due to charging or the like and a load is applied to the secondary batteries, the porous material shrinks while discharging air therein. On the other hand, when the secondary batteries shrink, for example, due to discharging or the like and the load is reduced, the porous material sucks air from periphery thereof, so that the porous material returns to an original shape and elasticity is restored. Thus, even when the secondary batteries expand and shrink while the battery pack is in use, a predetermined load can be stably applied to the secondary batteries.

### SUMMARY

However, according to a study of the present inventors, there were cases where, as a charge and discharge cycle proceeded, even when a state of charge (SOC) of the secondary batteries was reduced by discharging, a thickness of the porous material was not restored and elasticity did not return to an original level. This result indicates that, as illustrated in FIG. 12, as the charge and discharge cycle proceeds, the load applied to the secondary batteries becomes small in a low SOC region, that is, a region in which the thickness of the secondary batteries is reduced (SOC 15% in FIG. 2). Accordingly, there arises a problem in which a difference in load between when charging is performed and when discharging is performed (Δ load, a difference in load when SOC is 95% and when SOC is 15% in FIG. 12) is large. It was also newly found that, along with above-described situation, a so-called high-rate deterioration in which a metal Li is deposited or an active material is deteriorated is likely to occur.

In view of the above-described circumstances, the present disclosure has been devised and it is therefore a main object of the present disclosure to provide a method for controlling a battery pack and a controller are capable of suppressing increase in Δ load in a low SOC region when a charge and discharge cycle is repeated.

Through various examinations further conducted by the present inventors, it was found that, as the charge and discharge cycle proceeds, the porous elastic member cannot sufficiently take in air even when the SOC of the secondary batteries is reduced, so that the secondary batteries cannot return to an original size and the difference in load (Δ load) is large. Then, the present inventors arrived at the present disclosure.

The present disclosure provides a method for controlling a battery pack, the battery pack including a plurality of rectangular secondary batteries disposed in a predetermined arrangement direction, a porous elastic member disposed between adjacent ones of the rectangular secondary batteries in the arrangement direction, and a restriction mechanism that restricts the plurality of rectangular secondary batteries and the porous elastic member, the porous elastic member having a communication hole that communicates with outside and being elastically deformable. The control method includes a normal discharge step of discharging the rectangular secondary batteries such that a charge state of the rectangular secondary batteries does not become lower than a preset lower limit charge state, and a refresh discharge step of discharging the rectangular secondary batteries until the charge state of the rectangular secondary batteries becomes lower than the lower limit charge state when the normal discharge processing is not being performed.

Moreover, the present disclosure provides a controller that controls a battery pack, the battery pack including a plurality of rectangular secondary batteries disposed in a predetermined arrangement direction, a porous elastic member disposed between adjacent ones of the rectangular secondary batteries in the arrangement direction, and a restriction mechanism that restricts the plurality of rectangular secondary batteries and the porous elastic member, the porous elastic member having a communication hole that communicates with outside and being elastically deformable. The controller includes a normal discharge controller that executes normal discharge processing of discharging the rectangular secondary batteries such that a charge state of the rectangular secondary batteries does not become lower than a preset lower limit charge state, and a refresh discharge controller that executes refresh discharge processing of discharging the rectangular secondary batteries until the charge state of the rectangular secondary batteries becomes lower than the lower limit charge state when the normal discharge processing is not being performed.

In the art disclosed herein, the rectangular secondary batteries are forcibly discharged until the state of charge of the rectangular secondary batteries becomes lower than the lower limit charge state (lower limit SOC) during normal discharging, and thus refresh discharging of the rectangular secondary batteries is executed. In the refresh discharging, the thickness of the rectangular secondary batteries can be reduced to be relatively small, as compared to during normal discharging, and therefore, the porous elastic member can easily take in air. Accordingly, the porous elastic member can easily return to an original shape with an original size. Therefore, according to the art disclosed herein, reduction in load applied to the rectangular secondary batteries in the low SOC region when the charge and discharge cycle is repeated can be suppressed, and thus, increase in load fluctuation (Δ load) can be suppressed. Furthermore, occurrence of high-rate deterioration can be suppressed.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view schematically illustrating a battery pack according to an embodiment.

FIG. 2 is a perspective view schematically illustrating a secondary battery in FIG. 1.

FIG. 3 is a schematic longitudinal cross-sectional view taken along line III-III in FIG. 2.

FIG. 4 is a perspective view schematically illustrating an electrode body group attached to a sealing plate.

FIG. 5 is a perspective view schematically illustrating one electrode body.

FIG. 6 is a schematic view illustrating a structure of the electrode body.

FIG. 7 is a perspective view schematically illustrating a porous elastic member in FIG. 1.

FIG. 8 is a functional block diagram of a controller.

FIG. 9 is a flowchart illustrating an example of processing related to refresh discharging.

FIG. 10 is a graph illustrating a relationship between a charge and discharge cycle number and a load increase rate.

FIG. 11 is a graph illustrating a relationship between a charge and discharge cycle number and a resistance increase rate.

FIG. 12 is a graph illustrating a relationship between a charge and discharge cycle number and a loas according to the known art.

### DETAILED DESCRIPTION OF THE PREFERRED EMBODIMENTS

Preferred embodiments of the art disclosed herein will be described below with reference to the drawings as appropriate. Matters other than matters particularly mentioned in the present specification and necessary for the implementation of the present disclosure (for example, general configurations and manufacturing processes of a rectangular secondary battery and a battery pack that do not characterize the present disclosure) can be grasped as design matters of those skilled in the art based on the prior art in the relevant field. The battery pack disclosed herein can be implemented on the basis of the disclosure of the present specification and common technical knowledge in the relevant field.

Note that in the drawings below, the members and parts with the same operation are denoted by the same reference signs and the overlapping description may be omitted or simplified. Moreover, in the present specification, the notation “A to B” for a range signifies a value more than or equal to A and less than or equal to B, and is meant to encompass also the meaning of being “preferably more than A” and “preferably less than B.”

### [Battery Pack]

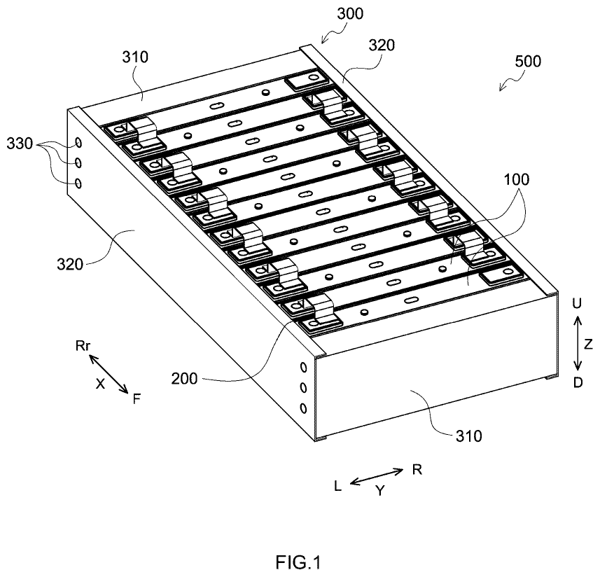

First, a battery pack that is a target of control disclosed herein will be described. FIG. 1 is a perspective view schematically illustrating a battery pack 500 according to an embodiment. The battery pack 500 here includes a plurality of rectangular secondary batteries 100, a plurality of porous elastic members 200, and a restriction mechanism 300. In the following description, reference signs L, R, F, Rr, U, and D in the drawings respectively denote left, right, front, rear, up, and down, and reference signs X, Y, and Z in the drawings respectively denote a short side direction of the rectangular secondary battery 100, and a long side direction and an up-down direction thereof that are orthogonal to the short side direction. The short side direction X also corresponds to an arrangement direction of the rectangular secondary batteries 100. These directions are defined however for convenience of explanation, and do not limit the manner in which the battery pack 500 is disposed.

The restriction mechanism 300 is a mechanism that restricts rectangular secondary batteries 100 and the porous elastic members 200 together. The restriction mechanism 300 is preferably configured to apply prescribed restriction pressure on the rectangular secondary batteries 100 and the porous elastic members 200 from the arrangement direction X. The restriction mechanism 300 here includes a pair of end plates 310, a pair of side plates 320, and a plurality of screws 330. The pair of end plates 310 is arranged in the predetermined arrangement direction X. The pair of end plates 310 is disposed on both ends of the battery pack 500 in the arrangement direction X. The pair of end plates 310 holds the rectangular secondary batteries 100 and the porous elastic members 200 therebetween in the arrangement direction X.

The pair of side plates 320 bridges over the pair of end plates 310. The pair of side plates 320 is fixed to the end plates 310 by the screws 330 so that a restriction load is generally about 10 to 15 kN, for example. Thus, the restriction load is applied on the rectangular secondary batteries 100 and the porous elastic members 200 from the arrangement direction X and accordingly, the battery pack 500 is held integrally. The restriction mechanism is, however, not limited to this example. In another example, the restriction mechanism 300 may alternatively include a plurality of restriction bands, restrict bars, or the like instead of the side plates 320.

The rectangular secondary battery 100 is a battery that is capable of being charged and discharged repeatedly. Note that in the present specification, the term “secondary battery” refers to general power storage devices that are capable of being charged and discharged repeatedly, and corresponds to a concept encompassing storage batteries, such as lithium-ion secondary batteries and nickel-hydrogen batteries, and capacitors, such as lithium-ion capacitors and electrical double-layer capacitors. The shape, the size, the number, the arrangement, the connection method, and the like of the rectangular secondary batteries 100 included in the battery pack 500 are not limited to the aspect disclosed herein, and can be changed as appropriate.

As illustrated in FIG. 1, the plurality of rectangular secondary batteries 100 are disposed between the pair of end plates 310 along the arrangement direction X (in other words, a thickness direction of the secondary batteries 100). The porous elastic members 200 are each disposed between the rectangular secondary batteries 100 that are adjacent in the arrangement direction X. That is to say, in the arrangement direction X, the rectangular secondary batteries 100 and the porous elastic members 200 are arranged alternately. However, as will be described in a modification below, some other member (for example, a heat resistance member or the like) may be further provided between the rectangular secondary battery 100 and the porous elastic member 200 that are adjacent to each other in the arrangement direction X. The plurality of rectangular secondary batteries 100 are connected to each other in series. However, a method for connecting the plurality of rectangular secondary batteries 100 is not limited to connection in series and, for example, the plurality of rectangular secondary batteries 100 may be connected in parallel, may be connected in multi-series and in multi-parallel, or the like.

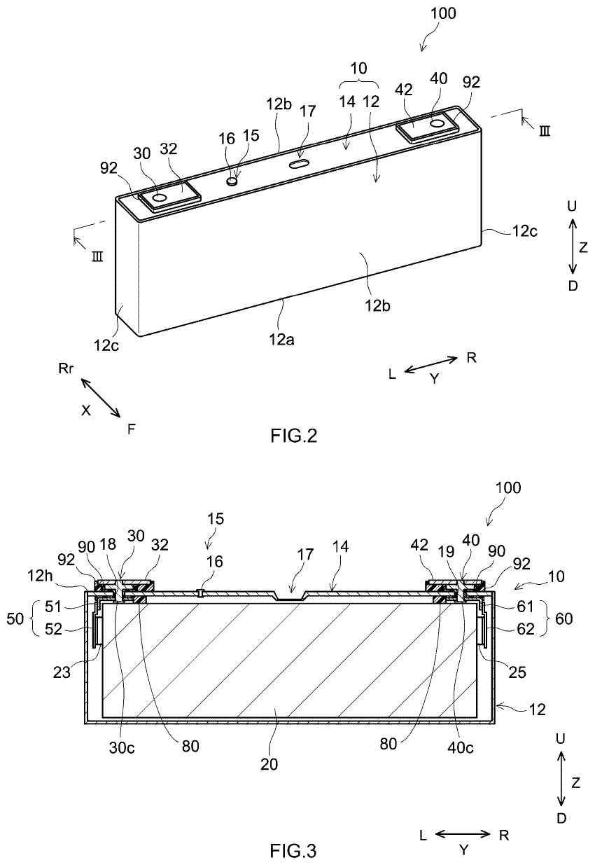

FIG. 2 is a perspective view of the rectangular secondary battery 100. As illustrated in FIG. 1 and FIG. 2, the rectangular secondary batteries 100 are arranged in the arrangement direction X through the porous elastic members 200 so that long side walls 12b, which are described below, oppose each other. In other words, the plurality of rectangular secondary batteries 100 are arranged in a direction in which the long side walls 12b are arranged in parallel. FIG. 3 is a schematic longitudinal cross-sectional view taken along line III-III in FIG. 2. As illustrated in FIG. 3, the rectangular secondary battery 100 includes a battery case 10, an electrode body group 20, a positive electrode terminal 30, a negative electrode terminal 40, a positive electrode current collector 50, a negative electrode current collector 60, and an electrolyte solution (not illustrated). The rectangular secondary battery 100 preferably includes a battery case 10, an electrode body group 20, and an electrolyte solution. The rectangular secondary battery 100 is a lithium-ion secondary battery here.

The battery case 10 is a housing that accommodates the electrode body group 20 and the electrolyte solution. As illustrated in FIG. 1, the external shape of the battery case 10 is a flat and bottomed cuboid shape (rectangular shape). A conventionally used material can be used for the battery case 10 without any particular limitation. The battery case 10 is preferably made of metal, and for example, more preferably made of aluminum, aluminum alloy, iron, iron alloy, or the like. As illustrated in FIG. 2, the battery case 10 includes an exterior body 12 having an opening 12h, and a sealing plate (lid body) 14 that seals the opening 12h. The battery case 10 preferably includes the exterior body 12 having the opening 12h and the sealing plate 14 that seals the opening 12h as described in this preferred embodiment.

As illustrated in FIG. 1, the exterior body 12 includes a bottom wall 12a, a pair of long side walls 12b extending from the bottom wall 12a and opposing each other, and a pair of short side walls 12c extending from the bottom wall 12a and opposing each other. The bottom wall 12a has a substantially rectangular shape. The bottom wall 12a opposes the opening 12h (see FIG. 3). The long side wall 12b has a flat shape. As illustrated in FIG. 1, the long side wall 12b is a surface that opposes the porous elastic member 200. The long side wall 12b is, here, in direct contact with the porous elastic member 200. However, the long side wall 12b may oppose the porous elastic member 200 via some other member. Note that, as used in this specification, the term “approximately rectangular” encompasses, in addition to a complete rectangular shape (a cuboid), for example, a shape in which corners that connect long sides and short sides of rectangular surfaces are rounded, a shape in which corner portions have notches, or the like.

In a plan view, the long side wall 12b is larger in area than the short side wall 12c. Although not particularly limited, in a high-capacity type that may be used as an on-vehicle battery or the like, the area of the long side wall 12b may be generally 10,000 mm² or more, is preferably 15,000 mm² or more, is more preferably 20,000 mm² or more, is still more preferably 25,000 mm² or more, and is particularly preferably 30,000 mm² or more. As described above, when the area of the long side wall 12b is large, air permeates less readily to the inside of the porous elastic member 200, which is described below, particularly to a center part in the long side direction Y. Thus, it is particularly effective to apply the art disclosed herein. From the viewpoint of obtaining the effect of the art disclosed herein at a high level, the area of the long side wall 12b is preferably generally 150,000 mm² or less.

The long side wall 12b is preferably horizontally long. That is to say, the length in the long side direction Y is preferably longer than the length in the up-down direction Z. The length (width) of the long side wall 12b in the long side direction Y is preferably 200 mm or more, and the length (height) thereof in the up-down direction Z is preferably 100 mm or more. As the distance between the center and the edge is longer in the long side direction Y, air permeates less readily to the center part in the long side direction Y, and therefore, it is more effective to apply the art disclosed herein. In the long side wall 12b, the ratio (ratio of height/width) of the length in the up-down direction Z to the length in the long side direction Y preferably satisfies 1/1 to ⅔, more preferably satisfies ⅔ to ⅓, and still more preferably satisfies ⅓ to 1/15.

The sealing plate 14 is a plate-like member that expands along an XY plane in FIG. 2. The sealing plate 14 is attached to the exterior body 12 so as to cover the opening 12h of the exterior body 12. The sealing plate 14 opposes the bottom wall 12a of the exterior body 12. The sealing plate 14 is substantially rectangular in shape. The battery case 10 is unified in a manner that the sealing plate 14 is joined (preferably, joined by welding) to a periphery of the opening 12h of the exterior body 12. The battery case 10 is hermetically sealed (closed).

When the battery case 10 includes the opening 12h, the exterior body 12 including the pair of the long side walls 12b and the second side walls 12c, and the sealing plate 14 that seals the opening 12h, the sealing plate 14 is joined to the periphery of the opening 12h of the exterior body 12, and the area of the long side wall 12b is 20,000 mm² or more, it is particularly effective to apply the art disclosed herein.

As illustrated in FIG. 3, a liquid injection hole 15, a gas discharge valve 17, and two terminal extraction holes 18 and 19 are provided in the sealing plate 14. The liquid injection hole 15 is provided for the purpose of injecting the electrolyte solution after the sealing plate 14 is assembled to the exterior body 12. The liquid injection hole 15 is sealed by a sealing member 16. The gas discharge valve 17 is configured to break when the pressure in the battery case 10 becomes more than or equal to a predetermined value so as to discharge the gas out of the battery case 10. The terminal extraction holes 18 and 19 penetrate the sealing plate 14 in the up-down direction Z. The terminal extraction holes 18 and 19 each have the inner diameter that enables the positive electrode terminal 30 and the negative electrode terminal 40, which have not been attached to the sealing plate 14 yet (before a caulking process), to pass therethrough.

The electrolyte solution may be similar to the conventional electrolyte solution, without particular limitations. The electrolyte solution is typically a nonaqueous electrolyte solution containing a nonaqueous solvent and a supporting salt (electrolyte salt). The electrolyte solution may additionally contain an additive as necessary. Examples of the nonaqueous solvent include carbonates such as ethylene carbonate, dimethyl carbonate, and ethyl methyl carbonate. The nonaqueous solvent preferably contains carbonates, particularly cyclic carbonates and chained carbonates. Examples of the supporting salt include fluorine-containing lithium salts such as lithium hexafluorophosphate (LiPF₆).

The positive electrode terminal 30 is disposed at an end part of the sealing plate 14 on one side in the long side direction Y (left end part in FIG. 2 and FIG. 3). The negative electrode terminal 40 is disposed at an end part of the sealing plate 14 on the other side in the long side direction Y (right end part in FIG. 2 and FIG. 3). As illustrated in FIG. 3, the positive electrode terminal 30 and the negative electrode terminal 40 extend from the inside to the outside of the sealing plate 14 through the terminal extraction holes 18 and 19. The positive electrode terminal 30 and the negative electrode terminal 40 are preferably fixed to the sealing plate 14. The positive electrode terminal 30 and the negative electrode terminal 40 are here caulked to a peripheral part of the sealing plate 14 that surrounds the terminal extraction holes 18 and 19 by the caulking process. Caulking parts 30c and 40c are formed at an end part of the positive electrode terminal 30 and the negative electrode terminal 40 on the exterior body 12 side (lower end part in FIG. 3).

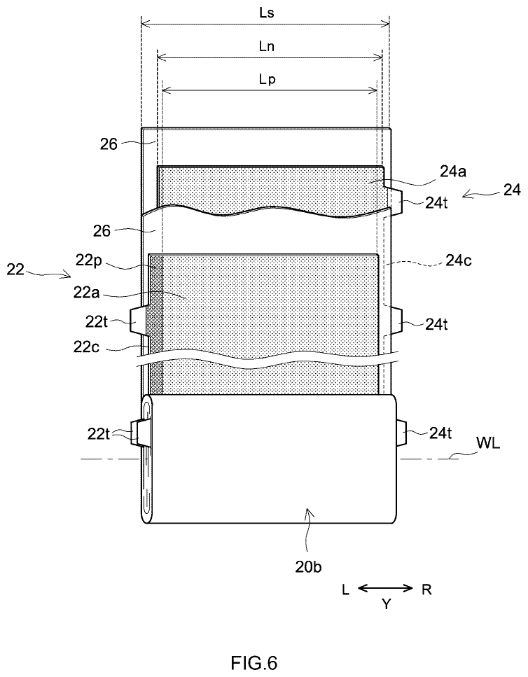

As illustrated in FIG. 3, the positive electrode terminal 30 is electrically connected to a positive electrode 22 (see FIG. 6) of the electrode body group 20 through the positive electrode current collector 50 inside the exterior body 12. The negative electrode terminal 40 is electrically connected to a negative electrode 24 (see FIG. 6) of the electrode body group 20 through the negative electrode current collector 60 inside the exterior body 12. The positive electrode terminal 30 is insulated from the sealing plate 14 by an internal insulation member 80 and a gasket 90. The negative electrode terminal 40 is insulated from the sealing plate 14 by the internal insulation member 80 and the gasket 90.

A positive electrode external conductive member 32 and a negative electrode external conductive member 42, each having a plate shape, are attached to an external surface of the sealing plate 14. The positive electrode external conductive member 32 is electrically connected to the positive electrode terminal 30. The negative electrode external conductive member 42 is electrically connected to the negative electrode terminal 40. The positive electrode external conductive member 32 and the negative electrode external conductive member 42 are insulated from the sealing plate 14 by an external insulation member 92. As illustrated in FIG. 1, a busbar that electrically connects the rectangular secondary batteries 100 to each other is attached to the positive electrode external conductive member 32 and the negative electrode external conductive member 42. Here, in the adjacent rectangular secondary batteries 100, the positive electrode external conductive member 32 of one rectangular secondary battery 100 and the negative electrode external conductive member 42 of the other rectangular secondary battery 100 are electrically connected to each other by the busbar. Thus, the battery pack 500 is electrically connected in series.

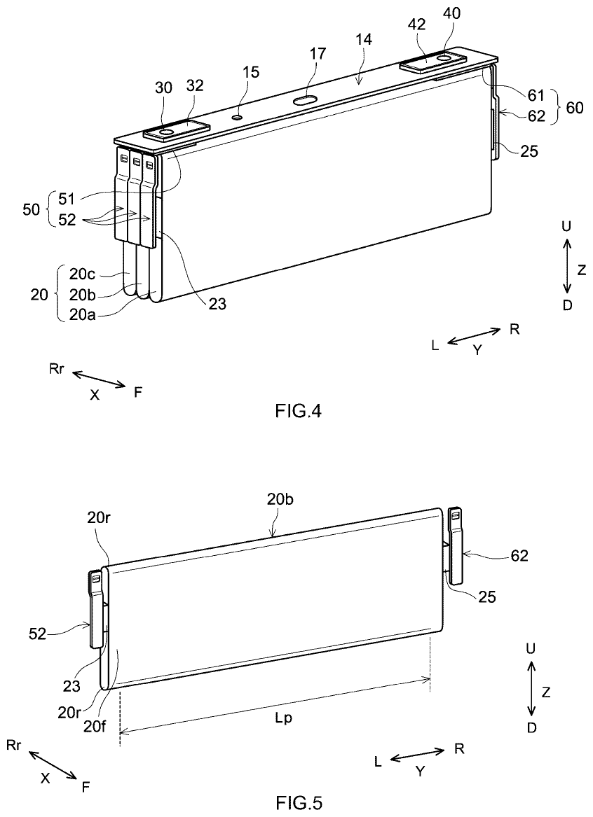

FIG. 4 is a perspective view schematically illustrating the electrode body group 20 attached to the sealing plate 14. The electrode body group 20 here includes a plurality of electrode bodies. The electrode body group 20 here includes three electrode bodies 20a, 20b, and 20c. The number of electrode bodies to be disposed in one exterior body 12 is, however, not limited in particular, may be one, may be two, and may be four or more. The electrode bodies 20a, 20b, and 20c are arranged in the short side direction X. The electrode bodies 20a, 20b, and 20c are electrically connected to each other in parallel here. The external shape of each of the electrode bodies 20a, 20b, and 20c is a flat shape. Each of the electrode bodies 20a, 20b, and 20c is a wound electrode body here. The electrode bodies 20a, 20b, and 20c are disposed inside the exterior body 12 with their winding axes WL (see FIG. 6) approximately parallel to the long side direction Y.

FIG. 5 is a perspective view schematically illustrating the electrode body 20b. A structure of the electrode body 20b may be similar to the conventional structure, without particular limitations. Although the electrode body 20b is described in detail below as an example, the electrode bodies 20a and 20c can also have the similar structure. The electrode body 20b has a pair of curved parts (R parts) 20r, and a flat part 20f coupling the pair of curved parts 20r. One curved part 20r (upper side in FIG. 5) opposes the sealing plate 14, and the other curved part 20r (lower side in FIG. 5) opposes the bottom wall 12a of the exterior body 12. The flat part 20f opposes the long side wall 12b of the exterior body 12. In the electrode bodies 20a, 20b, and 20c that are adjacent in the short side direction X, the respective flat parts 20f oppose each other.

FIG. 6 is a schematic view illustrating a structure of the electrode body 20b. The electrode body 20b includes the positive electrode 22, the negative electrode 24, and a separator 26. The electrode body 20b has a structure in which, here, the positive electrode 22 with a band shape and the negative electrode 24 with a band shape are stacked with the separator 26 with a band shape interposed therebetween and wound with the winding axis WL as a center. The winding axis WL direction is here approximately parallel to the long side direction Y. In another embodiment, the winding axis WL direction may be approximately parallel to the up-down direction Z. The electrode body 20b may be a stack type electrode body formed in a manner that a plurality of square (typically, rectangular) positive electrodes and a plurality of square (typically, rectangular) negative electrodes are stacked in an insulated state.

The positive electrode 22 may be similar to the conventional positive electrode, without particular limitations. As illustrated in FIG. 6, the positive electrode 22 has a positive electrode core body 22c, and a positive electrode active material layer 22a and a positive electrode protection layer 22p that are fixed on at least one surface of the positive electrode core body 22c. The positive electrode protection layer 22p is not essential, and can be omitted in another embodiment. The positive electrode core body 22c has a band shape. The positive electrode core body 22c is preferably made of metal, and more preferably made of a metal foil. The positive electrode core body 22c is an aluminum foil here.

At one end part of the positive electrode core body 22c in the long side direction Y (left end part in FIG. 6), a plurality of positive electrode tabs 22t are provided. The positive electrode tabs 22t protrude toward one side in the long side direction Y (left side in FIG. 6). The positive electrode tabs 22t protrude in the long side direction Y more than the separator 26. The positive electrode tab 22t constitutes a part of the positive electrode core body 22c here, and is made of a metal foil (aluminum foil). As illustrated in FIG. 3 to FIG. 6, the positive electrode tabs 22t are stacked at one end part in the long side direction Y (left end part in FIG. 3 to FIG. 6), and form a positive electrode tab group 23. The positive electrode tab group 23 is electrically connected to the positive electrode terminal 30 through the positive electrode current collector 50.

The positive electrode active material layer 22a is formed to have a band shape along a longitudinal direction of the positive electrode core body 22c as illustrated in FIG. 6. The positive electrode active material layer 22a includes a positive electrode active material that is capable of reversibly storing and releasing charge carriers. Examples of the positive electrode active material include a lithium-transition metal complex oxide. Further, the positive electrode active material layer 22a may contain an optional component other than the positive electrode active material, for example, various additive components such as a binder or a conductive material.

The positive electrode protection layer 22p is provided at a border part between the positive electrode core body 22c and the positive electrode active material layer 22a in the long side direction Y as illustrated in FIG. 6. The positive electrode protection layer 22p is formed to have a band shape along the positive electrode active material layer 22a. The positive electrode protection layer 22p contains inorganic filler (for example, alumina). The positive electrode protection layer 22p may contain an optional component other than the inorganic filler, such as a conductive material, a binder, or various additive components.

The negative electrode 24 may be similar to the conventional negative electrode, without particular limitations. As illustrated in FIG. 6, the negative electrode 24 has a negative electrode core body 24c, and a negative electrode active material layer 24a that is fixed on at least one surface of the negative electrode core body 24c. The negative electrode core body 24c has a band shape. The negative electrode core body 24c is preferably made of metal, and more preferably made of a metal foil. The negative electrode core body 24c is a copper foil here.

At one end part of the negative electrode core body 24c in the long side direction Y (right end part in FIG. 6), a plurality of negative electrode tabs 24t are provided. The negative electrode tabs 24t protrude toward one side in the long side direction Y (right side in FIG. 6). The negative electrode tabs 24t protrude in the long side direction Y more than the separator 26. The negative electrode tab 24t constitutes a part of the negative electrode core body 24c here, and is made of a metal foil (copper foil). As illustrated in FIG. 3 to FIG. 6, the negative electrode tabs 24t are stacked at one end part in the long side direction Y (right end part in FIG. 3 to FIG. 6), and form a negative electrode tab group 25. The negative electrode tab group 25 is provided at a position that is symmetrical to the positive electrode tab group 23 in the long side direction Y. The negative electrode tab group 25 is electrically connected to the negative electrode terminal 40 through the negative electrode current collector 60.

The negative electrode active material layer 24a is formed to have a band shape along a longitudinal direction of the negative electrode core body 24c as illustrated in FIG. 6. A length Ln of the negative electrode active material layer 24a in the long side direction Y is more than or equal to the length Lp of the positive electrode active material layer 22a in the long side direction Y. The negative electrode active material layer 24a includes a negative electrode active material that is capable of reversibly storing and releasing the charge carriers. Examples of the negative electrode active material include a carbon material such as graphite. The negative electrode active material layer 24a may contain an optional component other than the negative electrode active material, for example, various additive components such as a binder, a thickener, or a dispersant.

The separator 26 is disposed between the positive electrode 22 and the negative electrode 24. The separator 26 is a member that insulates between the positive electrode 22 the negative electrode 24. The electrode body 20b preferably includes the separator 26. A length Ls of the separator 26 in the long side direction Y is longer than or equal to the length Ln of the negative electrode active material layer 24a in the long side direction Y. The separator 26 is suitably a resin porous sheet (microporous film) made of polyolefin resin such as, for example, polyethylene (PE) or polypropylene (PP). A function layer (for example, an adhesion layer or a heat resistance layer) may be provided on a surface of the separator 26.

As illustrated in FIG. 3, the positive electrode current collector 50 forms a conductive path for electrically connecting the positive electrode terminal 30 and the positive electrode tab group 23 formed by the positive electrode tabs 22t. The positive electrode current collector 50 includes a positive electrode first current collector 51 and a positive electrode second current collector 52. The positive electrode first current collector 51 is attached to an inner surface of the sealing plate 14. The positive electrode second current collector 52 extends along the short side wall 12c of the exterior body 12. As illustrated in FIG. 3 to FIG. 5, the positive electrode second current collector 52 is attached to the electrode body 20b.

As illustrated in FIG. 3, the negative electrode current collector 60 forms a conductive path for electrically connecting the negative electrode terminal 40 and the negative electrode tab group 25 formed by the negative electrode tabs 24t. The negative electrode current collector 60 includes a negative electrode first current collector 61 and a negative electrode second current collector 62. The negative electrode first current collector 61 and the negative electrode second current collector 62 may have structures similar to those of the positive electrode first current collector 51 and the positive electrode second current collector 52 of the positive electrode current collector 50, respectively.

As illustrated in FIG. 1, the porous elastic members 200 are each disposed between the rectangular secondary batteries 100 in the arrangement direction X here. Note that it is only necessary that the porous elastic member 200 is disposed between at least two rectangular secondary batteries 100 that are adjacent in the arrangement direction X, and it is not always necessary that the porous elastic member 200 is disposed between all the rectangular secondary batteries 100. The porous elastic members 200 may be disposed between preferably 50% or more and more preferably 80% or more of the rectangular secondary batteries 100. The porous elastic member 200 may be a separate body from the rectangular secondary battery 100, and may be fixed to the rectangular secondary battery 100 to form a united body with the rectangular secondary battery 100. For example, the porous elastic member 200 may be held between the two rectangular secondary batteries 100 that oppose each other, or adhered to the rectangular secondary battery 100 by an adhesive, a tape, or the like. The shape, the size, the arrangement, or the like of the porous elastic member 200 can be determined as appropriate depending on the shape, the size, the capacity (degree of expansion and shrinkage), or the like of the rectangular secondary battery 100, for example.

The porous elastic member 200 is an elastically deformable member. The porous elastic member 200 is preferably configured to be elastically deformable at least in the arrangement direction X by sucking or discharging a gas. Preferably, the porous elastic member 200 shrinks when the rectangular secondary batteries 100 are restrained in a pressurized state or when the rectangular secondary batteries 100 are increased in thickness (expanded) by charging or the like and expands when the rectangular secondary batteries 100 are reduced in thickness by discharging or the like, so that the porous elastic member 200 can restore the thickness thereof. Although not particularly limited, the elastic force of the porous elastic member 200 may be generally 1 kN/mm to 1,000 kN/mm.

The porous elastic member 200 has a porous structure including a plurality of communication holes that communicate with the outside. Thus, the porous elastic member 200 can suck the gas from the periphery and move the sucked gas (air or the like) to inside when the porous elastic member 200 expands again after shrinking once. The porous elastic member 200 may have a three-dimensional mesh shape including communication holes that communicate with each other three-dimensionally. The porosity of the porous elastic member 200 (the volume of the pores/the volume of the porous elastic member 200) is preferably 10 to 90 vol %, more preferably 20 to 80 vol %, and still more preferably 25 to 75 vol %. The porous elastic member 200 is preferably formed of a resin material. Examples of the resin material include natural rubber, synthetic rubber, silicone resin, urethane resin, and the like.

When the rectangular secondary battery 100 expands in charging or the like and the thickness thereof in the arrangement direction X is increased, a load on the porous elastic member 200 becomes large. Thus, the porous elastic member 200 is compressed while discharging the air in the porous elastic member 200. Therefore, the excessive restriction load that is more than or equal to a predetermined load can be prevented from being applied on the rectangular secondary battery 100. On the other hand, if the rectangular secondary battery 100 shrinks in discharging or the like and the thickness thereof is reduced, the load on the porous elastic member 200 becomes small. Thus, the porous elastic member 200 sucks air from the outside to restore the original shape, so that elasticity recovers. Therefore, a predetermined load can be stably applied to the rectangular secondary battery 100.

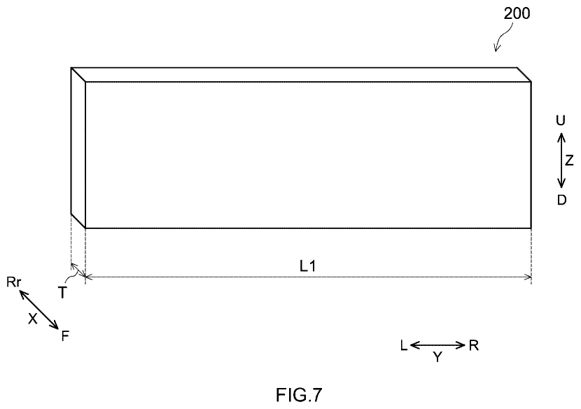

FIG. 7 is a perspective view schematically illustrating the porous elastic member 200. The thickness T of the porous elastic member 200 (length in the arrangement direction X) is, in a state before the porous elastic member 200 is assembled to the battery pack 500 and the porous elastic member 200 is compressed by a restriction mechanism 300, preferably 1 to 10 mm, more preferably 1 to 8 mm, and still more preferably 3 to 5 mm. The thickness T of the porous elastic member 200 is, in a state where the porous elastic member 200 is assembled to the battery pack 500 and is compressed, for example, by the restriction mechanism 300, preferably 2 to 9 mm, more preferably 3 to 8 mm, and still more preferably 3 to 8 mm. A total length L1 of the porous elastic member 200 in the long side direction Y may be approximately the same (generally, about ±1 cm) as the length (average length) Lp (see FIG. 6) of the positive electrode active material layer 22a in the long side direction Y. The total length L1 may be shorter than the length Ls of the separator 26 in the long side direction Y.

The porous elastic member 200 is here substantially rectangular in shape in a plan view. A total area of the porous elastic member 200 in the plan view is preferably 10,000 mm² or more, more preferably 15,000 mm² or more, and still more preferably 25,000 mm² or more. The ratio of the total area of the porous elastic member 200 to the area of the long side wall 12b is preferably generally 50% or more, more preferably 60% or more or further 70% or more, still more preferably 75% or more, and particularly preferably 80% or more. In these cases, since air permeates less readily to the inside of the porous elastic member 200, it is particularly effective to apply the art disclosed herein. Moreover, from the view point of obtaining the effect of the art disclosed herein at the high level, the ratio of the area is preferably generally 95% or less, preferably 90% or less, and more preferably 85% or less.

Note that, as used in the present specification, “the total area of the porous elastic member 200 in the plan view” is an area of the surface that is in contact with an opposing member (here, the long side wall 12b) (YX plane in FIG. 7). For example, if the porous elastic member 200 includes a plurality of parts, this area corresponds to the total area of these parts. Moreover, if the porous elastic member 200 includes a part that is not in contact with the opposing member, that is, a slit, a concave part, or the like, the area of the slit, the concave part, or the like is excluded.

The battery pack 500 is usable in various applications, and for example, can be suitably used as a motive power source for a motor (power source for driving) that is mounted in a vehicle such as a passenger car or a truck. The vehicle is not limited to a particular type, and may be, for example, a plug-in hybrid electric vehicle (PHEV), a hybrid electric vehicle (HEV), or a battery electric vehicle (BEV).

### [Controller of Battery Pack]

Incidentally, according to the study of the present inventors, in the known art, as a charging and discharging cycle progressed, the porous elastic member 200 could not sufficiently suck air and did not readily return to an original size in some cases. As a result, there is a problem that, when the charging and discharging cycle is repeated, a load applied on the rectangular secondary batteries 100 is reduced in a low SOC region (for example, a region where SOC is 30% or less, furthermore 20% or less, and particularly 15% or less), so that, even when charging and discharging are performed in the same SOC region, a difference in load (Δ load) between when charging is performed and when discharging is performed is increased.

Furthermore, according to the study of the present inventors, it was newly found that high-rate deterioration was likely to occur accordingly. That is, strong positive correlation between the Δ load and the high-rate deterioration (for example, increase in resistance) was recognized. Although it is not intended to limit interpretation, the present inventors think that a reason for this is as follows.

That is, in an environment where a change amount in the arrangement direction X is restricted (for example, as in this embodiment, in a mode where the electrode body 20b is accommodated in the battery case 10, a mode where a load is applied to suppress expansion and shrinkage of the electrode body 20b, or the like), normally, when the negative electrode 24 expands due to charging, the electrolyte solution included between the positive electrode 22 and the negative electrode 24 is pushed out. The pushed-out electrolyte solution returns to inside of the electrode body 20b when the negative electrode 24 shrinks due to discharging. However, when the Δ load is large at this time, an amount of the electrolyte solution that returns to inside of the electrode body 20b is increased, and an amount of the electrolyte solution that goes out and in is increased. Therefore, when charging and discharging are repeated, uniformization of distribution of the electrolyte solution cannot catch up, so that unevenness of a salt concentration (concentration gradient) in the electrode body 20b is likely to occur particularly in the long side direction Y (width direction). For example, while the amount of the electrolyte solution that goes out and in is increased and a concentration of the supporting salt is reduced at both end parts in the long side direction Y, the concentration of the supporting salt is likely to be increased in the center part in the long side direction Y. It is considered that this concentration gradient results in unevenness of resistance, for example, the both end parts in the long side direction Y have relatively high resistance, and as a result, high-rate deterioration is likely to occur.

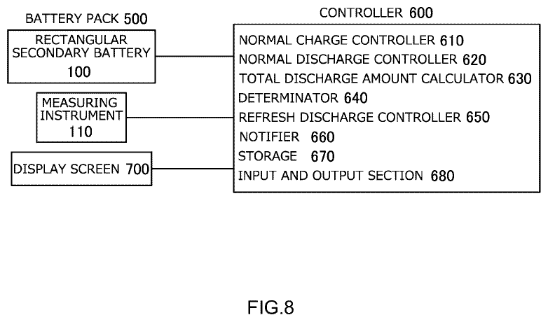

Then, a controller 600 (see FIG. 8) will be described next. The controller 600 is electrically connected to the battery pack 500 (specifically, the plurality of rectangular secondary batteries 100) and is configured to control charging and discharging of the battery pack 500 (or the rectangular secondary batteries 100). For the battery pack 500 (or the rectangular secondary batteries 100), charging and discharging are preferably controlled by the controller 600. The controller 600 is typically a computer or the like communicably connected to the battery pack 500 via a wire or wirelessly. The controller 600 is typically mounted on a product (for example, vehicle) with the battery pack 500. The controller 600 may be electrically connected to, for example, an electronic control unit (ECU) of the vehicle and may be built in the ECU of the vehicle.

There is no particular limitation on a hardware configuration of the controller 600. The controller 600 includes, for example, an interface (I/F) that receives print data from an external device such as a host computer or the like, a central processing unit (CPU) that executes an instruction of a control program, a read only memory (ROM) that stores programs that the CPU executes, a random access memory (RAM) used as a working area where a program is developed, and a storage device such as a memory or the like that stores the programs and various types of data.

The controller 600 may be a computer program that causes the CPU of the computer to operate as the controller 600. As for the computer program, a computer readable recording medium on which each processing of the controller 600 that will be described later is written may be employed. Examples of the recording medium include a semiconductor recording medium (for example, ROM or a nonvolatile memory card), an optical recording medium (for example, DCD, MO, MD, CD, or BD), a magnetic recording medium (for example, a magnetic tape or a flexible disk) or the like. The computer program can be transmitted to a server computer via the recording medium or a network such as the Internet, an intranet, or the like. In this case, the server computer is an embodiment of the controller 600.

FIG. 8 is a functional block diagram of the controller 600. As illustrated in FIG. 8, the controller 600 is communicably connected to an electrochemical measuring instrument 110 attached to the battery pack 500 (or the rectangular secondary batteries 100) and a display screen 700. The measuring instrument 110 is, for example, a voltmeter, an ammeter, or the like. The display screen 700 is, for example, a monitor, a display, a touch panel, or the like.

The controller 600 of this embodiment includes a normal charge controller 610, a normal discharge controller 620, a total discharge amount calculator 630, a determinator 640, a refresh discharge controller 650, a notifier 660, a storage 670, and an inputter/outputter 680. However, the total discharge amount calculator 630, the determinator 640, the notifier 660, and the storage 670 are not essential and, in another embodiment, some or all of them can be omitted. Components of the controller 600 are configured to be communicable with each other. Each component of the controller 600 may be configured by software and may be configured by hardware. Each component of the controller 600 may be realized by one or more processors and may be incorporated in a circuit.

The normal charge controller 610 is a controller that executes normal charge processing of charging the rectangular secondary batteries 100 such that a charge state of the rectangular secondary batteries 100 does not exceed a preset upper limit charge state (upper limit SOC) and inputs power to the rectangular secondary batteries 100 from the outside. A value of the upper limit SOC is set in advance and is stored in the storage 670. The value of the upper limit SOC is, for example, SOC 50 to 100%, SOC 80 to 100%, SOC 90 to 100%, or the like. From the viewpoint of achieving a high capacity, the value of the upper limit SOC is preferably SOC 90% or more, is more preferably SOC 95% or more, and is, as an example, SOC 95%.

The normal discharge controller 620 is a controller that executes normal discharge processing of discharging the rectangular secondary batteries 100 such that the charge state of the rectangular secondary batteries 100 does not become lower than a preset lower limit charge state (lower limit SOC) and supplies (outputs) power from the rectangular secondary batteries 100 to the outside (for example, a product, such as a vehicle or the like). A value of the lower limit SOC is set in advance and is stored in the storage 670. The value of the lower limit SOC is, for example, SOC 5 to 40%, SOC 10 to 30%, SOC 10 to 20%, or the like. From the viewpoint of achieving a high capacity, the value of the lower limit SOC is preferably SOC 30% or less, is more preferably SOC 20% or less, and is, as an example, SOC 15%.

Note that, for example, as in this embodiment, when the rectangular secondary batteries 100 are lithium-ion batteries, and particularly when the negative electrode active material is a carbon material, or the like, a battery voltage at the lower SOC is preferably generally 3.5 V or less (for example, 3.0±0.3 V), although the battery voltage can differ depending on a battery structure.

The total discharge amount calculator 630 is a controller that executes total discharge amount calculation processing of calculating a total discharge amount ΣQ of discharging performed by normal discharge controller 620. The total discharge amount calculator 630, for example, first acquires electrochemical data, that is, for example, data of a voltage, a current, or the like, measured during the normal discharge processing from the measuring instrument 110 via the inputter/outputter 680 at predetermined intervals. The total discharge amount calculator 630 calculates, for example, a discharge amount Q in one normal discharge processing. Note that, as an example, here, the total discharge amount calculator 630 calculates the discharge amount Q, but in another embodiment, the total discharge amount calculator 630 may be configured to acquire a value of the discharge amount Q, for example, from the ECU that is a controller at a higher level, or the like.

When the discharge amount Q is not stored in the storage 670, the total discharge amount calculator 630 sets the calculated discharge amount Q as the total discharge amount ΣQ. The total discharge amount ΣQ is preferably stored in the storage 670. When the total discharge amount ΣQ is already stored in the storage 670, the total discharge amount calculator 630 accumulates the calculated discharge amount Q to the total discharge amount ΣQ stored in the storage 670 to newly calculate the total discharge amount ΣQ. Then, the total discharge amount ΣQ of the storage 670 is updated. Note that the total discharge amount ΣQ stored in the storage 670 is typically reset when the refresh discharge processing that will be described below is performed to be zero again. In this case, the total discharge amount ΣQ stored in the storage 670 is a total of the discharge amount Q after the refresh discharge processing was performed last (most recently).

The determinator 640 is a controller that executes determination processing of determining, for example, based on a state of performance of the normal discharge processing in the normal discharge controller 620 whether the refresh discharge processing that will be described below is needed. The state of performance of the normal discharge processing is, for example, a number of times the normal discharge processing has been performed (number of times of discharging), a total discharge time, the total discharge amount ΣQ, or the like. The above-described information is acquired from the ECU or the measuring instrument 110 via the inputter/outputter 680 or is calculated based on information acquired from the measuring instrument 110 or the like.

In this embodiment, the determinator 640 is configured to determine based on whether the total discharge amount ΣQ calculated by the total discharge amount calculator 630 exceeds a preset threshold whether the refresh discharge processing is needed. The threshold is preset and is stored in the storage 670. The threshold may be determined, for example, based on a relationship between a charging and discharging cycle number that will be described in an example below and the Δ load. For example, a point where the Δ load exceeds an allowable value may be set as the threshold. Therefore, although not particularly limited, as an example, the threshold of the total discharge amount ΣQ is 8 kAh.

However, the determinator 640 may be configured to determine, for example, when the number of times discharging has been performed since the refresh discharge processing was performed last exceeds a predetermined number of times (threshold), when the total discharge time from when the refresh discharge processing was performed last exceeds a predetermined time (threshold), or the like, that the refresh discharge processing is needed.

The refresh discharge controller 650 is a controller that executes refresh discharge processing of forcibly discharging the rectangular secondary batteries 100 until the charge state of the rectangular secondary batteries 100 becomes lower than the lower limit SOC of the normal discharge processing (until the charge state becomes a refresh SOC). In this embodiment, the refresh discharge processing is executed when the normal charge controller 610 is not executing the normal charge processing and the normal discharge controller 620 is not executing the normal discharge processing. The refresh discharge controller 650 may be configured to execute refresh discharge processing in a situation where the SOC of the rectangular secondary batteries 100 is low, that is, for example, at a timing after the normal discharge controller 620 executes the normal discharge processing or before the normal charge controller 610 executes the normal charge processing. Thus, the rectangular secondary batteries 100 can be efficiently discharged up to the refresh SOC.

A value of the refresh SOC is preset and is stored in the storage 670. Although not particularly limited as long as the value of the refresh SOC is lower than the lower limit SOC, the value of the refresh SOC is preferably lower than the lower limit SOC by 5% or more, is more preferably lower than the lower limit SOC by 10% or more, and is still more preferably lower than the lower limit SOC, for example, by 15% or more. Specifically, from the viewpoint of obtaining the effect of the art disclosed herein at a high level, the value of the refresh SOC is preferably SOC 30% or less, is more preferably SOC 20% or less, is still more preferably SOC 10%, is particularly preferably SOC 5% or less and furthermore SOC 0% or less, and is, as an example, SOC 0%. However, from the viewpoint of suppressing deterioration of the rectangular secondary batteries 100, the value of the refresh SOC may be SOC 0% or more, SOC 1% or more, and SOC 3% or more.

Note that, for example, when the rectangular secondary batteries 100 are lithium-ion secondary batteries as in this embodiment, and particularly when the negative electrode active material is a carbon material, or the like, the battery voltage at the refresh SOC is preferably generally 2.0 V or less (for example, about 2.0±0.3 V), although the battery voltage can differ depending on a battery structure. A difference between the battery voltage at the lower limit SOC and the battery voltage at the refresh SOC is preferably 0.5 V or more.

In the refresh discharge processing, a state of the refresh SOC is preferably maintained for a preset maintenance time. From the viewpoint of obtaining the effect of the art disclosed herein at a high level, the maintenance time is preferably 30 seconds or more, is more preferably 3 minutes or more, and is still more preferably 5 minutes or more. The maintenance time is preferably 30 minutes or less in consideration of convenience for a user, a deterioration state of the rectangular secondary batteries 100, or the like.

The refresh discharge controller 650 is preferably configured to execute the refresh discharge processing, based on an instruction by the user in consideration of the convenience for the user or the like. The refresh discharge controller 650 is preferably configured to execute the refresh discharge processing on a regular basis. In one preferred aspect, the refresh discharge controller 650 is configured to, when it is determined in the determination processing by the determinator 640 that the refresh discharge processing is needed, execute the refresh discharge processing. In this embodiment, the refresh discharge controller 650 is configured to, when it is determined that the total discharge amount ΣQ exceeds the threshold, execute the refresh discharge processing.

The notifier 660 is a controller that executes notification processing of notifying the user of a state of charging and discharging of the rectangular secondary batteries 100 or the like via the inputter/outputter 680. In one preferred aspect, the notifier 660 is configured to notify the user before the refresh discharge controller 650 executes the refresh discharge processing. In this embodiment, the notifier 660 is configured to, when it is determined in the determination processing by the determinator 640 that the refresh discharge processing is needed, notify the user that the refresh discharge processing is needed. The notifier 660 may be configured to perform the notification, for example, by indicating a character, an illustration, or the like on the display screen 700 or the like, or perform the notification by beep sound or voice, such as a voice guidance or the like.

The notifier 660 is preferably configured to notify the user of contents of processing that is being performed by the controller 600, that is, for example, that the normal charge controller 610 is executing the normal charge processing, that the normal discharge controller 620 is executing the normal discharge processing, that the refresh discharge controller 650 is executing the refresh discharge processing, or the like. For example, with the notifier 660 configured to notify the user that the refresh discharge controller 650 is executing the refresh discharge processing, the user can grasp that the user cannot normally use a product (for example, vehicle) on which the battery pack 500 is mounted for a predetermined time. The notifier 660 may be configured to notify the user of the charge state (SOC) of the battery pack 500 (or the rectangular secondary batteries 100), for example, by a number, an illustration, or the like.

The notifier 660 is preferably configured to, for example, when it is determined in the determination processing by the determinator 640 that the refresh discharge processing is needed, display a first selection message that urges the user to select whether to perform the refresh discharge processing or to, when the refresh discharge processing is performed, display a second selection message that urges the user to input a timing (date and time, or the like) of the refresh discharge processing when the refresh discharge processing is performed.

Various parameters, such as, for example, the value of the upper limit SOC in the normal charge processing, the value of the lower limit SOC in the normal discharge processing, the value of the total discharge amount ΣQ, the threshold in the determination processing, the value of the refresh SOC in the refresh discharge processing, or the like, are stored in the storage 670. One or more of charge and discharge patters including at least the refresh discharge processing may be further stored in the storage 670 in advance. The charge and discharge patterns preferably include a first charge and discharge pattern in which only the refresh discharge processing is executed, a second charge and discharge pattern in which, after the refresh discharge processing, the normal charge processing of charging the discharge secondary batteries 100 to an approximately full charge state (for example, to SOC 90% or more and furthermore to SOC 95% or more) is performed in succession. Reservation information of the refresh discharge processing may be further stored in the storage 670.

In the controller 600 described above, in performing the refresh discharge processing, the thickness of the rectangular secondary batteries 100 can be reduced to be smaller than that in regular normal discharge processing, so that the porous elastic member 200 can readily take in air. As a result, the porous elastic member 200 can readily return to the original shape with the original size (particularly, the original thickness of the arrangement direction X). Accordingly, reduction in the load applied to the rectangular secondary batteries 100 in the low SOC region when the charging and discharging cycle is repeated can be suppressed, and thus load fluctuation (Δ load) when the SOC fluctuates can be reduced. Furthermore, increase in unevenness of the salt concentration (concentration gradient) in the electrode body 20b in the long side direction Y can be suppressed, and occurrence of high-rate deterioration can be prevented beforehand.

### [Method for Controlling Battery Pack]

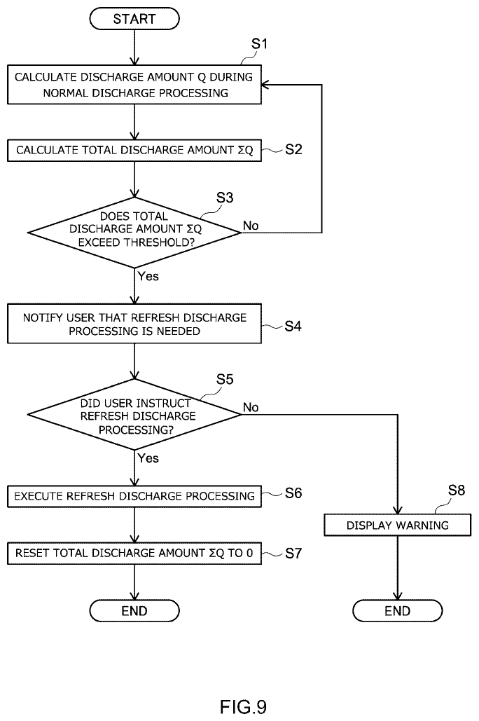

FIG. 9 is a flowchart illustrating an example of processing according to refresh discharging of this embodiment. In a control method disclosed herein, for example, when the normal discharge controller 620 executes the normal discharge processing, in accordance with steps illustrated in the flowchart of FIG. 9, control up to execution of the refresh discharge processing is performed.

In Step S1, when first the normal discharge processing is started by the normal discharge controller 620, the electrochemical data (for example, change of a voltage, a current, or the like) measured by the measuring instrument 110 is input in the total discharge amount calculator 630 via the inputter/outputter 680. In the total discharge amount calculator 630, the discharge amount Q is calculated based on the data. In one example, a discharge current value of the rectangular secondary batteries 100 is measured at a certain interval using an ammeter during the normal discharge processing, and the discharge amount Q is calculated by integrating the discharge current value. Then, for example, when single-time execution of the normal discharge processing is completed and the discharge amount Q is obtained, the process proceeds to Step S2.

In Step S2, the total discharge amount calculation processing is executed by the total discharge amount calculator 630. The total discharge amount calculator 630 calculates the total discharge amount of discharging performed in the normal discharge processing. When the discharge amount Q is not stored in the second electrode current collector 60, the total discharge amount calculator 630 obtains the discharge amount Q calculated in Step S1 as it is as the total discharge amount ΣQ and the obtained total discharge amount ΣQ is stored in the storage 670. On the other hand, when the total discharge amount ΣQ (typically, the total discharge amount ΣQ of discharging performed up to a present time after the refresh discharge processing was performed last) is stored in the storage 670, the total discharge amount calculator 630 sums the discharge amount Q calculated in Step S1 and the total discharge amount ΣQ stored in the storage 670 to obtain the total discharge amount ΣQ. Then, the total discharge amount ΣQ in the storage 670 is updated, and the process proceeds to Step S3.

In Step S3, the determination processing is executed by the determinator 640. In this embodiment, based on the state of performance of the normal discharge processing, the determinator 640 determines whether the refresh discharge processing is needed. Specifically, the determinator 640 determines whether the total discharge amount ΣQ calculated in Step S2 exceeds the preset threshold. The refresh discharge processing can be executed at a proper timing by setting the threshold as appropriate and comparing the total discharge amount ΣQ with the threshold. When the determinator 640 determines that the total discharge amount ΣQ exceeds the threshold, a determination result in Step S3 of FIG. 9 is YES, and the process proceeds to Step S4.

On the other hand, when the determinator 640 determines that the total discharge amount ΣQ does not exceed the threshold, elasticity of the porous elastic member 200 has not been largely reduced in the low SOC region. In this case, because the refresh discharge processing may not be executed, the determination result in Step S3 of FIG. 9 is NO, and the process returns to Step S1. Then, the discharge amount Q is integrated each time the normal discharge processing is executed, and the total discharge amount ΣQ is updated.

In Step S4, the notifier 660 executes the notification processing. Specifically, the notifier 660 notifies the user that the refresh discharge processing is needed. Thus, before the refresh discharge processing is actually executed, the user can recognize that the refresh discharge processing is needed. The notifier 660 displays, for example, a message saying “Maintenance (the refresh processing) is needed.” or the like on the display screen 700. Then, the process proceeds to Step S5.

In Step S5, the user selects whether to perform the refresh discharge processing and, when the refresh discharge processing is performed, a timing for the refresh discharge processing. While the refresh discharge processing is performed, the normal discharge processing and the normal charge processing cannot be executed. That is, the product (for example, vehicle) on which the battery pack 500 is mounted cannot be normally used. Therefore, whether to perform the refresh discharge processing and, when the refresh discharge processing is performed, a timing of the refresh discharge processing are adjusted in accordance with circumstances and a schedule of the user, and thus, convenience for the user can be increased. However, as will be described in modifications blow, in another embodiment, this step may be omitted, and the refresh discharge processing may be set to be automatically performed (for example, a charge and discharge pattern may be set).

In this embodiment, the notifier 660 displays the first selection message saying, “Do you want to perform maintenance (refresh discharge processing) now?” or the like on the display screen 700. Then, when the user selects “YES” (that is, instructs the normal discharge processing), for example, via the selection screen (not illustrated) or the like, a determination result of Step S5 in FIG. 9 is YES, and the process proceeds to Step S6. On the other hand, for example, in a case where it is inconvenient to perform the refresh discharge processing immediately because there is a schedule to normally use the battery pack 500 (execute the normal discharge processing) immediately or for like reason, when the user selects “NO”, for example, via the selection screen (not illustrated) or the like, the notifier 660 further displays the second selection message saying, “Do you want to reserve maintenance (refresh discharge processing)?” or the like on the display screen 700.

Then, when the user selects “YES” (that is, instructs the refresh discharge processing), for example, via the selection screen (not illustrated) or the like, a reservation screen via which reservation information used for executing the refresh discharge processing is input is displayed on the display screen 700. The reservation information includes, for example, information of date and time when the refresh discharge processing is started and information of a charge and discharge pattern including the refresh discharge processing. The charge and discharge pattern may be selected, for example, from a plurality of charge and discharge patterns stored in the storage 670 (for example, from the first charge and discharge pattern and the second charge and discharge pattern), and may be freely set by the user. When the user inputs the date and time when the refresh discharge processing is started and the charge and discharge pattern via the reservation screen (not illustrated), the reservation information of the refresh discharge processing is stored in the storage 670. Then, also in this case, the determination result in Step S5 in FIG. 9 is YES, and the process proceeds to Step S6.

On the other hand, when the second selection message is displayed and then the user selects “NO”, for example, via the selection screen (not illustrated) or the like, the determination result in Step S5 in FIG. 9 is NO, and the process proceeds to Step S8. In Step S8, the notifier 660 displays a warning saying, “If maintenance (refresh discharge processing) is not performed, the life of the battery is possibly shortened.” or the like on the display screen 700. Then, control is terminated.

In Step S6, in a state where the normal charge processing and the normal discharge processing are not being performed, the refresh discharge controller 650 executes the refresh discharge processing. Specifically, the refresh discharge controller 650 forcibly discharges the rectangular secondary batteries 100 to the refresh SOC. Furthermore, the rectangular secondary batteries 100 are preferably maintained to be in a state of the refresh SOC for a predetermined maintenance time. Note that, when “YES” is selected in response to the first message in Step S5, after Step S5, the refresh discharge processing is executed immediately. When the rectangular secondary batteries 100 are largely recessed due to the refresh discharge processing, the porous elastic member 200 can readily suck the gas. Thus, the porous elastic member 200 can be caused to appropriately return to the original shape. Then, the process proceeds Step S7.

On the other hand, when “YES” is selected in response to the second selection message in Step S5, the refresh discharge processing is executed in accordance with the reservation information. At this time, if the first charge and discharge pattern is selected via the reservation screen, the refresh discharge controller 650 executes only the refresh discharge processing. On the other hand, if the second charge and discharge pattern is selected via the reservation screen, the refresh discharge controller 650 executes the refresh discharge processing, and then, the normal charge processing of charging the rectangular secondary batteries 100 to an approximately full charged state (for example, to SOC 90% or more) is executed by the normal charge controller 610 in succession to the refresh discharge processing. Then, the process proceeds to Step S7.

In Step S7, the total discharge amount ΣQ stored in the storage 670 is deleted. In other words, the total discharge amount ΣQ is reset to be zero. At this time, the reservation information stored in the storage 670 may be deleted with the total discharge amount ΣQ. Then, control is terminated.

Examples related to the present disclosure will be described below, but it is not intended to limit the present disclosure to the examples.

In this test example, validity of the refresh discharge processing was checked. Specifically, a porous elastic member that had a communication hole and was elastically deformable in a thickness direction was prepared first. Next, a rectangular secondary battery (lithium-ion secondary battery) and the porous elastic member were held between a pair of restriction jigs (restriction mechanism) in the arrangement direction to restrict the rectangular secondary battery and the porous elastic member such that a thickness of the porous elastic member was reduced to 80% of the thickness before the restriction, thereby producing a test battery. Note that a load cell used for load measurement was installed in one of the pair of restriction jigs and the restriction jig was configured to measure a load applied to long side walls of the rectangular secondary battery (surfaces each opposing the porous elastic member).

### [Measurement of Δ Load]

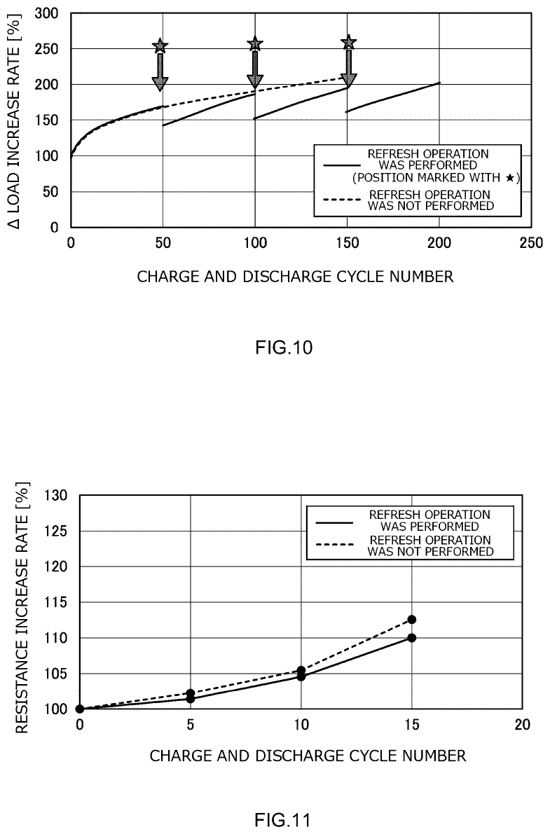

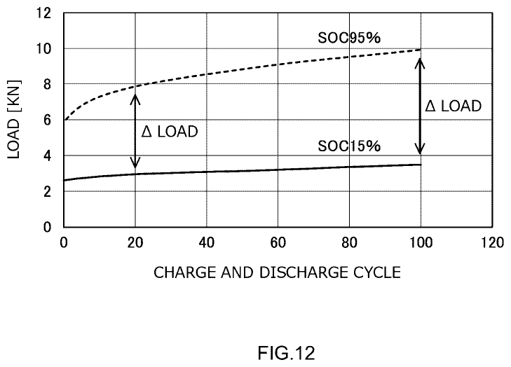

In the following manner, transition of a difference in load (Δ load) between when charging was performed and when discharging was performed was measured. First, in a temperature environment of 25° C., the constructed test batteries were charged and discharged in a range of SOC 15 to 95% a plurality of times, and the then load was measured by the load cell. Note that, for a test battery of an example, the refresh discharge processing was performed every 50 cycles. Specifically, the rectangular secondary battery was forcibly discharged to SOC 0% to reduce the load of the porous elastic member. On the other hand, for a test battery of a comparative example, the refresh discharge processing was not performed. Then, for each cycle, the Δ load was calculated by subtracting the load when SOC was 15% from the load when SOC was 95%, and was represented in terms of a Δ load increase rate where the Δ load of a first cycle was 100%. Results are illustrated in FIG. 10.

FIG. 10 is a graph illustrating a relationship between a charge and discharge cycle number and a load increase rate (%, relative value). Note that, in FIG. 10, a point indicating a cycle in which the refresh discharge processing was performed in the example is marked by a star. In a test battery of the example in which the refresh discharge processing was performed, after the refresh discharge processing, the load when SOC was 15% was high and, as illustrated in FIG. 10, increase in the Δ load was suppressed to be relatively small, as compared to the test battery of the comparative example in which the refresh discharge processing was not performed. This is presumably because the porous elastic member was caused to readily take in air by the refresh discharge processing, and thus, could readily return to the original shape with the original size. This result indicates a significance of the art disclosed herein.

### [Measurement of IV Resistance]

Two rectangular secondary batteries (example and comparative example) having the same structure were prepared, and high-rate deterioration thereof were measured in the following manner. First, after each of the two rectangular secondary batteries was adjusted to a state where SOC was 50%, constant current discharging of each of the two rectangular secondary batteries was performed at 240 A for 10 seconds, and a discharge resistance was measured. Next, a battery voltage Δ V that dropped during 10 seconds was read, and an IV resistance (initial resistance) was calculated based on the battery voltage Δ V and a discharge current value (240 A).

Next, a durability test was performed in a temperature environment of 25° C. Specifically, as one cycle, each of the rectangular secondary batteries was adjusted to a state where SOC was 20%, constant current charging of each of the two rectangular secondary batteries was performed at a charge rate of 2C for 30 minutes, followed by 10 minutes break, and constant current discharging thereof was performed at a discharge rate of ⅕C for 180 minutes, followed by 10 minutes break, and this cycle was repeated 15 times. At this time, for the rectangular secondary battery of the example, the refresh discharge processing was performed every 3 cycles. Specifically, after discharging of the charge and discharge cycle, the rectangular secondary battery was forcibly discharged to SOC 0% to reduce the load on the porous elastic member, the rectangular secondary battery was caused to return to an original SOC and the charge and discharge cycle was resumed. On the other hand, for the rectangular secondary battery of the comparative example, the refresh discharge processing was not performed. Then, similar to the initial resistance, the IV resistance was measured every 5 cycles, and a resistance increase rate for each of the rectangular secondary batteries was calculated based on a ratio of the IV resistance to the initial resistance after the durability test. Results are illustrated in FIG. 11.

FIG. 11 is a graph illustrating a relationship between the charge and discharge cycle number and a resistance increase rate (%, relative value). As illustrated in FIG. 11, in the rectangular secondary battery of the example on which the refresh discharge processing was performed, increase in resistance was suppressed to be relatively small, as compared to the rectangular secondary battery of the comparative example on which the refresh discharge processing was not performed, and high-rate deterioration was suppressed. A difference in increase in resistance between the rectangular secondary batteries of the example and the comparative example was more remarkable as the cycle number increases. This result indicates a significance of the art disclosed herein.

Although preferred embodiments of the present disclosure have been described above, they are merely examples. The present disclosure can be implemented in various other modes. The present disclosure can be implemented based on the contents disclosed in this specification and the technical common sense in the relevant field. The techniques described in the scope of claims include those in which the embodiments exemplified above are variously modified and changed. For example, a part of the aforementioned embodiment can be replaced by another modified example, and the other modified example can be added to the aforementioned embodiment. Additionally, the technical feature may be deleted as appropriate unless such a feature is described as an essential element.

(First Modification) For example, in the above-described embodiment, the battery pack 500 is connected in series, and the controller 600 is configured to control charging and discharging of the battery pack 500. However, the present disclosure is not limited thereto. For example, when the battery pack 500 is connected in parallel, the controller 600 may be configured to individually control charging and discharging each of the rectangular secondary batteries 100.

### (Second Modification)

For example, in the above-described embodiment, the determinator 640 is configured to determine base on the state of performance of the normal discharge processing whether the refresh discharge processing is needed. Specifically, the determinator 640 is configured to, when the total discharge amount ΣQ calculated by the total discharge amount calculator 630 exceeds the preset threshold, determine that the refresh discharge processing is needed. However, the present disclosure is not limited thereto. The determinator 640 may be configured, for example, to detect that the load applied to the rectangular secondary batteries 100 has reached a predetermined value and then determine that the refresh discharge processing is needed, and may be configured to, when a predetermined time has elapsed since the refresh discharge processing was performed last, determine that the refresh discharge processing is needed.

### (Third Modification)

For example, in the embodiment of FIG. 9 described above, the flowchart includes Step S5, and the refresh discharge controller 650 is configured to receive an instruction by the user and execute the refresh discharge processing. In other words, the user determines whether the refresh discharge processing is needed and a timing of the refresh discharge processing. However, the present disclosure is not limited thereto. The refresh discharge controller 650 may be configured to automatically execute the refresh discharge processing, for example, based on a determination result of the determinator 640. For example, a step that is performed when the determinator 640 determines that the refresh discharge processing is needed is stored in the storage 670 in advance, and the refresh discharge controller 650 may be configured to automatically execute the refresh discharge processing, based on the step.

As an example, the refresh discharge controller 650 may be configured, for example, to select a time slot (for example, a preset time slot at night) in which the normal discharge processing is less likely executed and execute automatically the refresh discharge processing. Note that, as the time slot at night, a time slot at midnight in which a night time electricity rate is applied is preferably selected. The refresh discharge controller 650 may be configured to, for example, when the normal charge processing is executed in a time slot at night for the first time after the determinator 640 determines that the refresh discharge processing is needed, execute the refresh discharge processing first and then execute the normal discharge processing. That is, the refresh discharge processing may be executed in combination with the normal charge processing.

### (Fourth Modification)

For example, in the above-described embodiment, the porous elastic member 200 is disposed between the rectangular secondary batteries 100 that are adjacent in the arrangement direction X, and both surfaces of the porous elastic member 200 in the arrangement direction X are in contact with the long side walls 12b of the rectangular secondary batteries 100. However, the different member may exist between the rectangular secondary battery 100 and the porous elastic member 200. Examples of the different member that may exist between the rectangular secondary battery 100 and the porous elastic member 200 include a non-porous insulation film; a heat-resistant member including high-melting-point resin; a heat-resistant member including a resin material and ceramic particles; a heat insulation member including a nanoporous body mainly containing silica aerogel or silica, or the like; and the like. The shape, the size, and the arrangement of the different member can be determined as appropriate depending on, for example, the shape, the size, the position of the gas flow channel, or the like of the porous elastic member 200. For example, the different member may have a sheet shape or the same shape as the porous elastic member 200.

As described above, the following items are given as specific aspects of the art disclosed herein.

First Item: A method for controlling a battery pack, the battery pack including a plurality of rectangular secondary batteries disposed in a predetermined arrangement direction, a porous elastic member disposed between adjacent ones of the rectangular secondary batteries in the arrangement direction, and a restriction mechanism that restricts the plurality of rectangular secondary batteries and the porous elastic member, the porous elastic member having a communication hole that communicates with outside and being elastically deformable, the method including a normal discharge step of discharging the rectangular secondary batteries such that a charge state of the rectangular secondary batteries does not become lower than a preset lower limit charge state, and a refresh discharge step of discharging the rectangular secondary batteries until the charge state of the rectangular secondary batteries becomes lower than the lower limit charge state when the normal discharge step is not being performed.
Second Item: The method for controlling a battery pack according to the first item, the method further including a determination step of determining based on a state of performance of the normal discharge step whether the refresh discharge step is needed, and being configured such that, when it is determined in the determination step that the refresh discharge step is needed, the refresh discharge step is executed.
Third Item: The method for controlling a battery pack according to the second item, the method further including a total discharge amount calculation step of calculating a total discharge amount of discharging performed in the normal discharge step, and being configured such that, in the determination step, whether the refresh discharge step is needed is determined based on whether the total discharge amount exceeds a preset threshold.
Fourth Item: The method for controlling a battery pack according to the second or third item, the method further including a notification step of notifying a user that the refresh discharge step is needed when it is determined in the determination step that the refresh discharge step is needed.
Fifth Item: The method for controlling a battery pack according to the fourth item, the method being configured such that, after the notification step, the refresh discharge step is started based on an instruction by the user.
Sixth Item: The method for controlling a battery pack according to any one of the first to fifth items, the method being configured such that, in the refresh discharge step, the rectangular secondary batteries are discharged until the charge state of the rectangular secondary batteries becomes 10% or less.
Seventh Item: The method for controlling a battery pack according to any one of the first to sixth items, the method further including a normal charge step of charging the rectangular secondary batteries until the state of charge of the rectangular secondary batteries becomes 90% or more, and being configured such that, in executing the normal charge step, the refresh discharge step is executed first and then the normal charge step is executed.
Eighth Item: A controller that controls a battery pack, the battery pack including a plurality of rectangular secondary batteries disposed in a predetermined arrangement direction, a porous elastic member disposed between adjacent ones of the rectangular secondary batteries in the arrangement direction, and a restriction mechanism that restricts the plurality of rectangular secondary batteries and the porous elastic member, the porous elastic member having a communication hole that communicates with outside and being elastically deformable, the controller including a normal discharge controller that executes normal discharge processing of discharging the rectangular secondary batteries such that a charge state of the rectangular secondary batteries does not become lower than a preset lower limit charge state, and a refresh discharge controller that executes refresh discharge processing of discharging the rectangular secondary batteries until the charge state of the rectangular secondary batteries becomes lower than the lower limit charge state when the normal discharge processing is not being performed.

### DESCRIPTION OF REFERENCE CHARACTERS

10 Battery case
20 Electrode body group
20a, 20b, 20c Electrode body
100 Rectangular secondary battery
3200 Porous elastic member
300 Restriction mechanism
500 Battery pack
600 Controller
610 Normal charge controller
620 Normal discharge controller
630 Total discharge amount calculator
640 Determinator
650 Refresh discharge controller
660 Notifier
670 Storage

What is claimed is:

1. A method for controlling a battery pack,
the battery pack including
a plurality of rectangular secondary batteries disposed in a predetermined arrangement direction,
a porous elastic member disposed between adjacent ones of the rectangular secondary batteries in the arrangement direction, and
a restriction mechanism that restricts the plurality of rectangular secondary batteries and the porous elastic member,
the porous elastic member having a communication hole that communicates with outside and being elastically deformable,
the method comprising:
a normal discharge step of discharging the rectangular secondary batteries such that a charge state of the rectangular secondary batteries does not become lower than a preset lower limit charge state; and
a refresh discharge step of discharging the rectangular secondary batteries until the charge state of the rectangular secondary batteries becomes lower than the lower limit charge state when the normal discharge step is not being performed.

2. The method for controlling a battery pack according to claim 1, further comprising:
a determination step of determining based on a state of performance of the normal discharge step whether the refresh discharge step is needed,
wherein
when it is determined in the determination step that the refresh discharge step is needed, the refresh discharge step is executed.

3. The method for controlling a battery pack according to claim 2, further comprising:
a total discharge amount calculation step of calculating a total discharge amount of discharging performed in the normal discharge step,
wherein
in the determination step, whether the refresh discharge step is needed is determined based on whether the total discharge amount exceeds a preset threshold.

4. The method for controlling a battery pack according to claim 2, further comprising:
a notification step of notifying a user that the refresh discharge step is needed when it is determined in the determination step that the refresh discharge step is needed.

5. The method for controlling a battery pack according to claim 4,
wherein
after the notification step, the refresh discharge step is started based on an instruction by the user.

6. The method for controlling a battery pack according to claim 1,
wherein
in the refresh discharge step, the rectangular secondary batteries are discharged until the charge state of the rectangular secondary batteries becomes 10% or less.

7. The method for controlling a battery pack according to claim 1, further comprising:
a normal charge step of charging the rectangular secondary batteries until the state of charge of the rectangular secondary batteries becomes 90% or more,
wherein
in executing the normal charge step, the refresh discharge step is executed first and then the normal charge step is executed.

8. A controller that controls a battery pack, the battery pack including a plurality of rectangular secondary batteries disposed in a predetermined arrangement direction, a porous elastic member disposed between adjacent ones of the rectangular secondary batteries in the arrangement direction, and a restriction mechanism that restricts the plurality of rectangular secondary batteries and the porous elastic member, the porous elastic member having a communication hole that communicates with outside and being elastically deformable, the controller comprising:
a normal discharge controller that executes normal discharge processing of discharging the rectangular secondary batteries such that a charge state of the rectangular secondary batteries does not become lower than a preset lower limit charge state; and
a refresh discharge controller that executes refresh discharge processing of discharging the rectangular secondary batteries until the charge state of the rectangular secondary batteries becomes lower than the lower limit charge state when the normal discharge processing is not being performed.
